(19) United States
(12) Patent Application Publication
(10) Pub. No.: US 2014/0211772 A1
(43) Pub. Date: Jul. 31, 2014

(54) MULTI-WAN DEVICE AND METHOD OF UPDATING ROUTING TABLE

(71) Applicants: HONG FU JIN PRECISION INDUSTRY (ShenZhen) CO., LTD, (US); HON HAI PRECISION INDUSTRY CO., LTD., New Taipei (TW)

(72) Inventor: JING LIN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/888,420

(22) Filed: May 7, 2013

(30) Foreign Application Priority Data
Jan. 31, 2013 (CN) 2013100387927

(51) Int. Cl. H04W 88/10

(52) U.S. Cl. CPC H04W 88/10
USPC 370/338

(57) ABSTRACT

A multi-WAN interface device includes a first WAN interface, a second WAN interface, an application module, a detection module, a register module, an updating module and a routing table. The first WAN interface connects to a first network and the second WAN interface connects a second network. The application module applies the first network and the second network for a mobile IP home address and a care-of-address. The detection module detects whether it is necessary for switching between the first network and the second network. The register module registers the care-of-address to the home agent. The updating module updates the default routing table of the first network. A method for the multi-WAN interface device updating the routing table is also provided.

### BACKGROUND

1. Technical Field

The disclosure relates to network communications, and particularly to a Multi-WAN device and a method of updating a routing table of the multi-WAN device.

2. Description of Related Art

WiFi is a wireless Local Area Network (LAN) technology and a wireless broadband access technology. Recently a large number of WIFI Access Points are running around the world, and provide wireless network service which are free or paid.

Worldwide Interoperability for Microwave Access (WiMAX) is also a wireless broadband access technology, and many operators around the world use the WiMAX technology to set up wireless broadband access networks.

It is a big research subject to achieve seamless switching between WIFI and WIMAX.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an application environment diagram of one embodiment of a Multi-WAN device as disclosed.

FIG. 2 is a function module diagram of one embodiment of the multi-WAN device of FIG. 1.

FIG. 3 is a function module diagram of another embodiment of the multi-WAN device of FIG. 1.

FIG. 4 is a general flowchart of one embodiment of a method of the multi-WAN device updating routing table as disclosed.

FIG. 5 is a specific flowchart of another embodiment of a method of the multi-WAN device updating routing table as disclosed.

FIG. 6 is a specific signal structure diagram of the multi-WAN device of FIG. 1 transmitting a first network packets by a second network.

### DETAILED DESCRIPTION

The disclosure is illustrated by way of example and not by way of limitation in the figures of the accompanying drawings in which like references indicate similar elements.

It should be noted that references to “an” or “one” embodiment in this disclosure are not necessarily to the same embodiment, and such references mean “at least one.”

The word “module” as used hereinafter, refers to logic embodied in hardware or firmware, or to a collection of software instructions, written in a programming language, such as, for example, JAVA, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

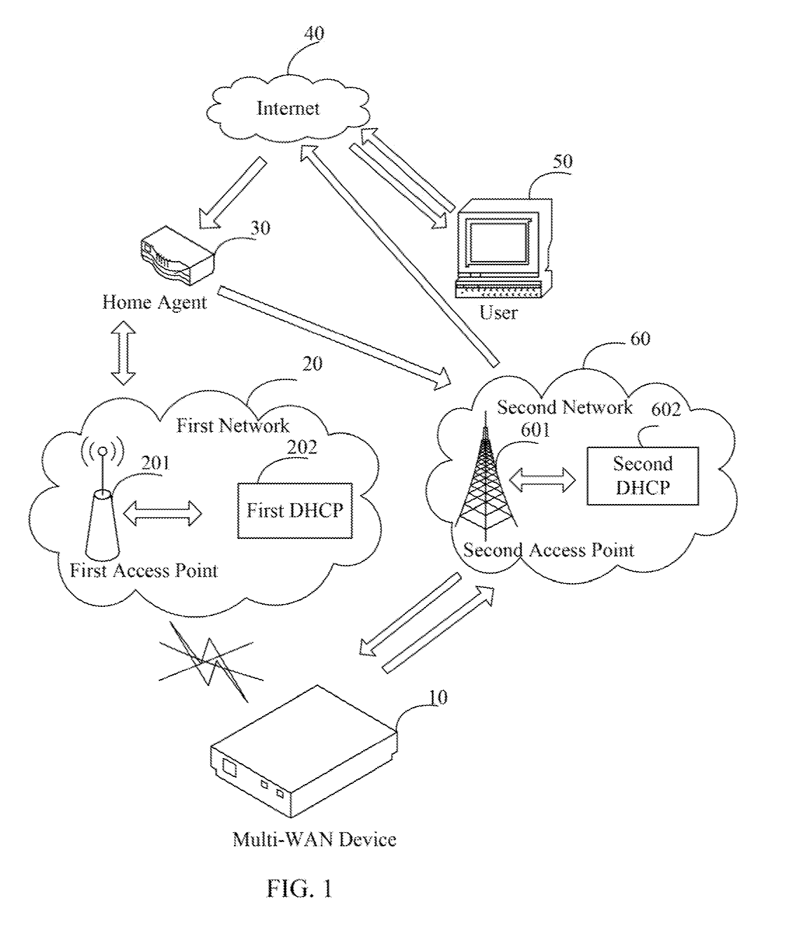

FIG. 1 is an application environment diagram of one embodiment of a multi-WAN device 10. In one embodiment, a first network 20 comprises a first access point 201 and a first dynamic host configuration protocol (DHCP) 202. A second network 60 comprises a second access point 601 and a second DHCP 602. When any of communications of the first network and the second network is failure or blockage, another network would be used for communicating. In order to keep continuous communication between a user 50 and an internet 40 when interfaces of the multi-WAN 10 are switched one to another, many modules storied the multi-WAN device 10 are combined to achieve seamless connection resumption between networks. In one embodiment, the multi-WAN device comprises a plurality of interfaces which may be Wireless Fidelity (WiFi), Worldwide Interoperability for Microwave Access (WiMAX) or Long Team Evolution (LTE), for example.

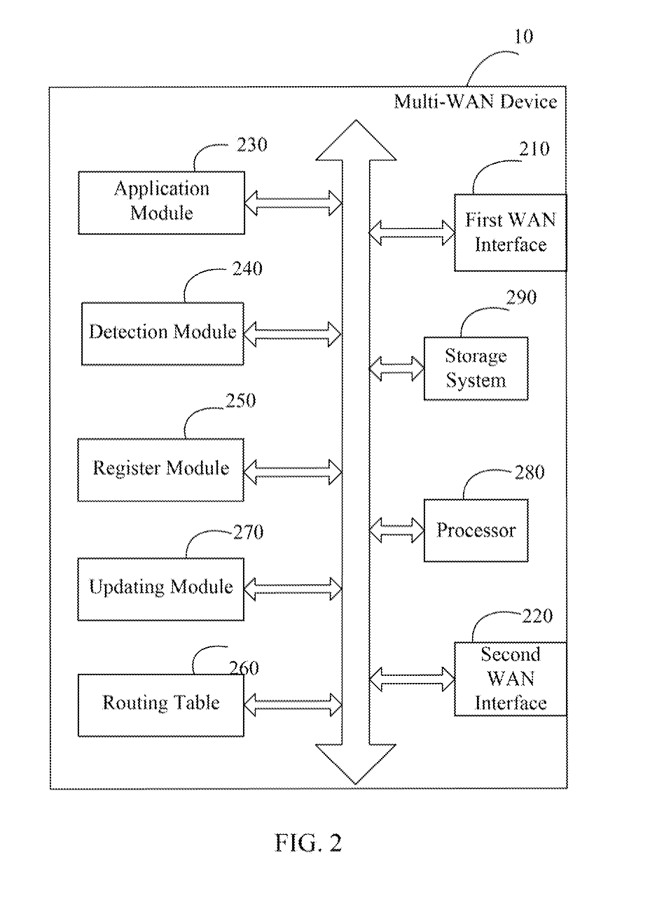

FIG. 2 is a function module diagram of one embodiment of the multi-WAN device 10 of FIG. 1. In one embodiment, the multi-WAN device 10 comprises a first WAN interface 210, a second WAN interface 220, an application module 230, a detection module 240, a register module 250, an updating module 270, a routing table 260, a storage system 290 and a processor 280. These modules comprise software programs which are stored in storage system 290 and the processor 280 run the software programs to achieve functions of these modules. The routing table 260 is a routing table of the first network 20 which comprises default routing rules. In one embodiment, the default routing rules are transmitting rules from the first WAN interface 210 to the home agent 30 about data transport.

In one embodiment, the multi-WAN device 10 applies for a first IP address as a mobile IP address from the first network 20 by the first WAN interface 210 and communicates with the first network 20, the home agent 30, the internet 40 and the user 50. During the communication of the multi-WAN device 10, communication quality of the first network 20 may be bad while communication quality of the second network 60 is well. At this time, the multi-WAN device 10 applies for a second IP address as a care-of-address from the second network 60 by the second WAN interface 220. Then the home agent 30 binds the care-of-address and the mobile IP address, and transmits the information of binding to the multi-WAN device 10.

At the same time, a tunnel between the second network 60 and the home agent 30 is enabled, and information of the tunnel is transmitted to the multi-WAN device 10. The multi-WAN device 10 regards the information of binding as a new routing rule and adds the new routing rule to the routing table 260 of the first network 20, and updates the default data transport routing rules of the routing table 260 of the first network 20 according to the received information of the tunnel. Thus the multi-WAN device 10 can transmit the communication packets of the first network 20 through the second network 60 based on the updating routing table 260 of the first network 20, and achieve seamless connection resumption from the first network 20 to the second network 60.

For example, assuming that the first network 20 is a WiFi network and the second network 60 is a WiMAX network, accordingly, the first access point 201 is an access point (AP), the second access point 601 is a base station (BS), the first WAN interface 210 is the WiFi interface, and the second WAN interface 220 is the WiMAX interface.

Generally, mobile nodes, home agent and foreign agent are defined in the mobile internet protocol. An IP address gotten by the mobile nodes which is in a local link (such as a link of the home agent 30 in FIG. . . . ) is called a home address. However, an IP address gotten by the mobile nodes which is in a foreign link (such as a link of the . . . in FIG. . . . ) is called a foreign address.

The multi-WAN device 10 connects the WiFi interface to AP, and the application module 230 applies for WiFi IP address as a mobile IP home address from the WiFi network by the WiFi network interface. In one embodiment, the application module 230 can apply for the mobile IP address directly from the AP or indirectly from the first DHCP by the AP.

The multi-WAN device 10 regards the AP as a foreign agent(FA) which communicates with the internet 40 and the user 50 by the home agent 30. During the communication between the multi-WAN device 10 and the user 50, the multi-WAN device 10 continuously detects the communication quantity (quality) of the first network 20.

In one embodiment, the detection module 240 detects and determines whether a carrier to interference plus noise ratio(CINR) of the WiFi network is less than a default threshold corresponding to the WiFi network. If the CINR of the WiFi network is less than the default threshold corresponding to the WiFi network, it indicates the communication quality of the WiFi network is not well. Thus, the detection module 240 scans the CINR of the WiMAX network. If the CINR of the WiFi network is not less than the default threshold corresponding to the WiFi network, it indicates the communication quality of the WiFi network is well and certainly the WiFi network is used to communicate.

The detection module 240 detects and determines whether the CINR of the WiMAX network is more than a default threshold corresponding to the WiMAX network. In one embodiment, if the CINR of the WiMAX network is more than the default threshold corresponding to the WiMAX network, it indicates that the communication quality of the WiMAX network is very well and the WiFi network is switched to the WiMAX network. If the CINR of the WiMAX network is not more than the default threshold corresponding to the WiMAX network, it indicates the communication quality of the WiMAX network is also not well and the WiFi network is still used to communicate. In conclusion, the detection module 240 continuously detects the CINR of the WiFi or the WiMAX in order to determine whether it is necessary to switch the WiFi network to the WiMAX network, and provides a better network environment for communication between the multi-WAN device 10 and the user 50.

After switching the WiFi network to the WiMAX network, the application module 230 applies for a WiMAX IP address as a care-of-address from the WiMAX network by the WiMAX interface. In one embodiment, the care-of-address can be acquired from the second DHCP 602. In another embodiment, the care-of-address also can be acquired from the BS.

Next, the register module 250 registers the care-of-address to the home agent 30. In one embodiment, the register module 250 transmits register information of the care-of-address to the BS and informs the BS of transmitting the register information of the care-of-address to the home agent 30. After the home agent 30 receives the register information of the care-of-address, confirms the care-of-address and transmits the success information of registering the care-of-address to the multi-WAN device 10.

After the care-of-address is successful registered, the home agent 30 binds the care-of-address and the mobile IP address, and transmits the information of binding to the updating module 270. The updating module 270 regards the information of binding as a new routing rule adding to the routing table 260 of the WiFi network. However, the information of binding has it's deadline, and once the deadline is past, the information of binding needs to be acquired again. In other words, the information of binding needs to be updated. However, the update of binding will have an impact on the routing table of the home agent 30. Because of all the above, and also in order to guarantee the security of networks, both the home agent 30 and the BS need have a same key, so it is necessary to confirm the register of the care-of-address when information of binding is updating.

At last, the BS enables a tunnel between the WiMAX network and the home agent 30 so that the WiMAX network can transmit data via the tunnel, and it is necessary to update the default data transmit rules of the routing table of the WiFi network based on information of the tunnel by the updating module 270.

Therefore, the multi-WAN device 10 can transmit the communication packets of the WiFi network by the WiMAX network based on the updated routing rules of the WiFi network.

The following is the specific communication process after the first network is switched to the second network. In one embodiment, the first WAN interface 210 is the WiFi interface and the second WAN interface 220 is the WiMAX interface, for example. At first, the first access point 201 is the WiFi access point , and the second access point 601 is the WiMAX BS.

When the packets are transmitted from the multi-WAN device 10 to the user 50 by the internet, the WiMAX network transmits directly through the mobile IP. When the packets are transmitted from the user 50 to the multi-WAN device 10 by the internet, the packets need to be transported through the home agent 30 and the WiMAX BS.

When the packets are transmitted from the user 50 to the multi-WAN device 10 by the internet, because the user 50 only recognizes packets of the home agent 30, the packets from the user 50 to the multi-WAN device 10 would be intercepted by the home agent 30. The home agent 30 adopts compress technology and adds a new header to the packets before closing the packets, and maintains the original header unchanged. Then the packets are transmitted to the WiMAX BS through the tunnel set up by the home agent 30. After receiving the packets, the WiMAX BS cancels the header of packets and transmits the packets to the multi-WAN device 10.

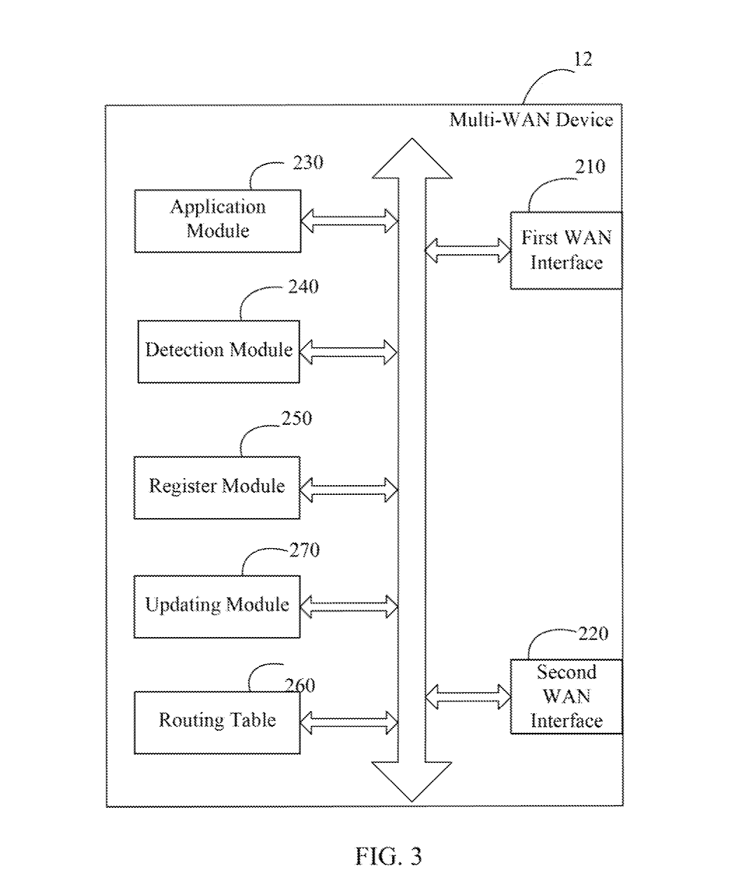

FIG. 3 is a function module diagram of another embodiment of the multi-WAN device of FIG. 1. In one embodiment, the multi-WAN device 10 comprises a first WAN interface 210, a second WAN interface 220, an application module 230, a detection module 240, a register module 250, an updating module 270 and a routing table 260. The all modules have same function as the modules of FIG. 2, so FIG. 3 would not be introduced again.

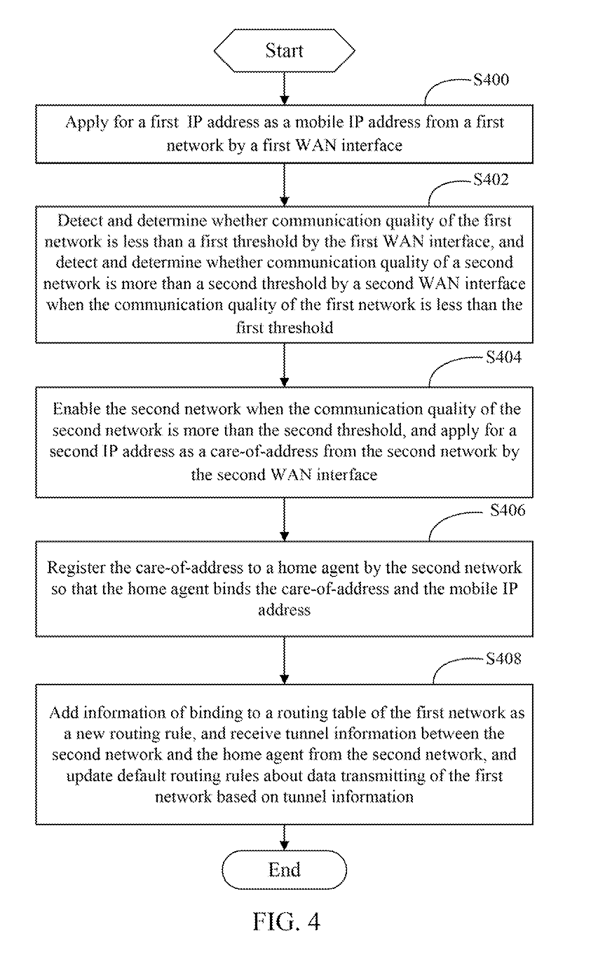

FIG. 4 is a general flowchart of embodiment of the method of the multi-WAN device updating routing table as disclosed. The method is applied for the multi-WAN device 10, and achieved by the modules of the FIG. 2 or FIG. 3. In one embodiment, the modules of FIG. 2 is used for achieving the method. Apparently the modules of FIG. 3 also can achieve the method.

In step S400, the application module 230 applies for a first IP address as a mobile IP address from the first network 20 by the first WAN interface 210.

In step S402, the detection module 240 detects and determines whether communication quality of the first network 20 is less than a first threshold by the first WAN interface 210, and detects and determines whether communication quality of the second network 60 is more than a second threshold by the second WAN interface 220 when the communication quality of the first network 20 is less than the first threshold.

In step S404, the detection module 240 enables the second network 60 when the communication quality of the second network 60 is more than the second threshold. Then the application module 230 applies for a second IP address as a care-of-address from the second network 60 by the second WAN interface 220.

In step S406, the register module 250 registers the care-of-address to the home agent 30 by the second network 60 so that the home agent 30 binds the care-of-address and the mobile IP address and transmits information of binding.

In step S408, the updating module 270 regards the information of binding as a new routing rule and adds to a routing table of the first network 20, and receives tunnel information relating to the second network 20 and the home agent 30 from the second network 20, and updates default routing rules about data transmitting of the first network 20 based on the tunnel information.

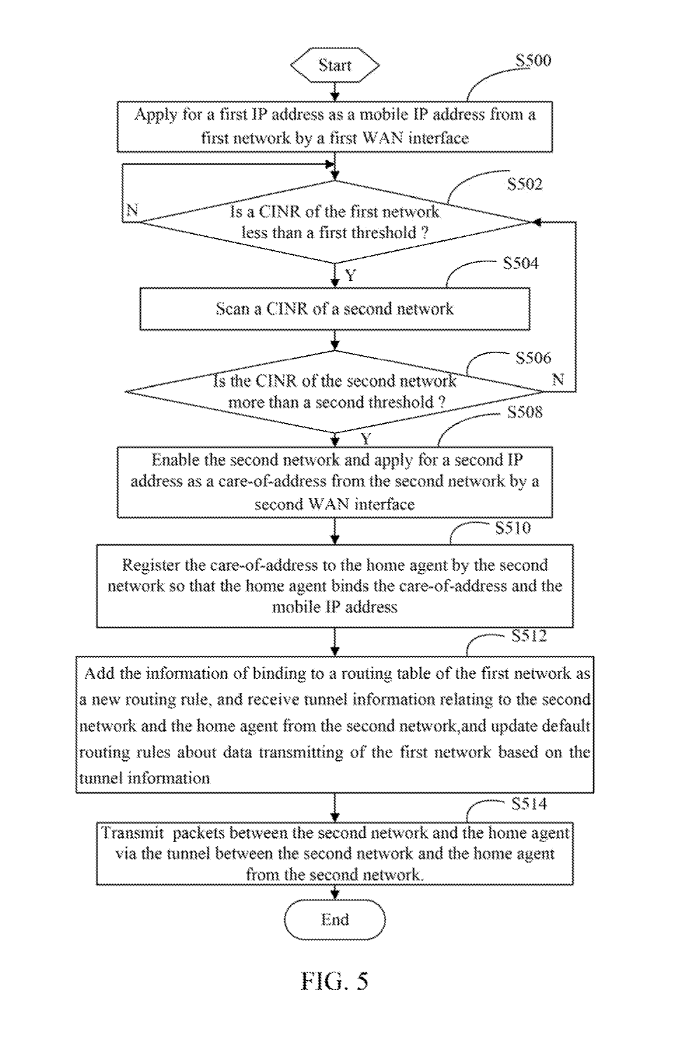

FIG. 5 is a specific flowchart of embodiment of the method of the multi-WAN device updating routing table as disclosed. The method is applied for the multi-WAN device 10, and achieved by the modules of the FIG. 2 or FIG. 3. In one embodiment, the modules of FIG. 2 is used for achieving the method. Apparently the modules of FIG. 3 also can achieve the method.

In step S500, the application module 230 applies for a first IP address as a mobile IP address from the first network 20 by the first WAN interface 210.

In step S502, the detection module 240 detects and determines whether CINR of the first network 20 is less than the first threshold, when the CINR of the first network 20 is not less than the first threshold, it indicates that the communication quantity of the first network 20 is well, so keep on detecting and determining whether CINR of the first network 20 is less than the first threshold. when the CINR of the first network 20 is less than the first threshold, go to the step S504.

In step S504, the detection module 240 scans CINR of the second network 60.

In step S506, the detection module 240 detects and determines whether CINR of the second network 60 is more than the second threshold, when the CINR of the second network 60 is not more than the second threshold, it indicates that the communication quantity (quality) of the second network 60 is not well, go to the step S502. when the CINR of the second network 60 is more than the second threshold, it indicates that the communication quantity (quality) of the second network 60 is well, switch the first network 20 to the second network 60.

In step S508, Enabling the second network 60 and the application applies for a second IP address as a care-of-address from the second network by the second WAN interface.

In step S510, the register module 250 registers the care-of-address to the home agent 30 by the second network 60 so that the home agent 30 binds the care-of-address and the mobile IP address and transmits information of binding. however, the binding has its (it's) deadline, once the deadline is past, information of binding must be acquired again, in other words, the information of binding needs to be updated. However, the update of binding has an impact on the routing table of the home agent 30, because of all the above, and also in order to guarantee the security of networks, both the home agent 30 and the second access point need have the same key, so it is necessary to confirm the registration of the care-of-address when information of binding is updating.

In step S512, the updating module 270 regards the information of binding as a new routing rule and adding to a routing table of the first network 20, and receives tunnel information relating to the second network 60 and the home agent 30 from the second network 60, and updates default routing rules about data transmitting of the first network 20 based on the tunnel information.

In step S514, the tunnel relating to the second network 60 and the home agent 30 from the second network 60 is used for transmitting the packets between the second network 60 and the home agent 30.

The following is the specific communication process after the first network 20 switches to the second network 60. In one embodiment, the first WAN interface 210 is the WiFi interface and the second WAN interface 220 is the WiMAX interface, which is as a example to be introduced. At first, the first access point 201 is the WiFi access point (AP), and the second access point 601 is the WiMAX BS.

When the packets are transmitted from the multi-WAN device 10 to the user 50 by the internet, the WiMAX network transmits directly through the mobile IP. When the packets are transmitted from the user 50 to the multi-WAN device 10 by the internet, the packets need to be transported through the home agent 30 and the WiMAX BS.

When the packets are transmitted from the user 50 to the multi-WAN device 10 by the internet, because the user 50 only recognizes packets of the home agent 30, the packets from the user 50 to the multi-WAN device 10 would be intercepted by the home agent 30. The home agent 30 adopts compress technology and adds a new header to the packets before closing the packets, and maintains the original header unchanged. Then the packets are transmitted to the WiMAX BS through the tunnel set up by the home agent 30. After receiving the packets, the WiMAX BS cancels the header of packets and transmits the packets to the multi-WAN device 10.

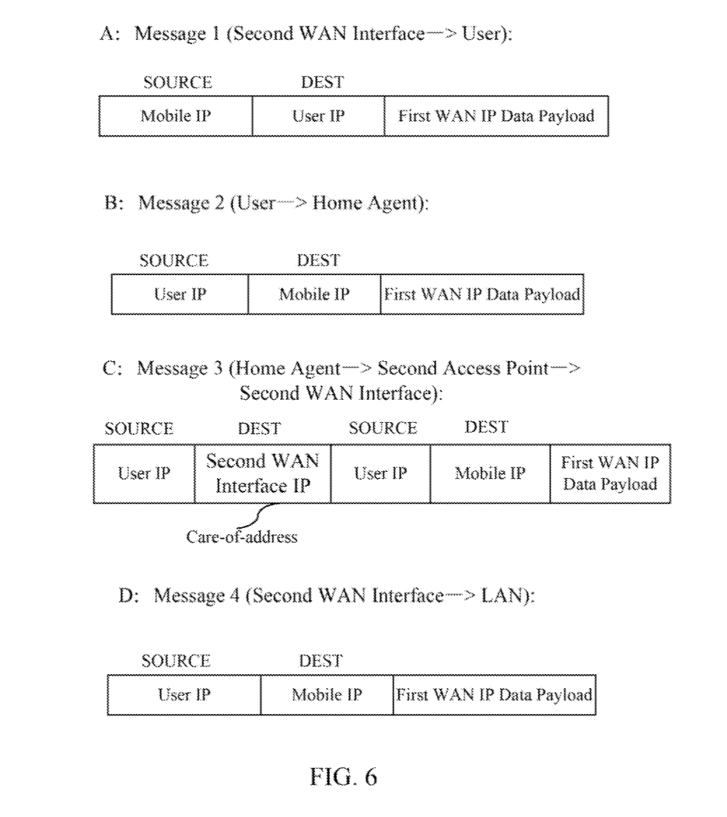

FIG. 6 is a specific signal structure diagram of the multi-WAN device 10 transmitting the first network 20 packets by the second network 60. The signal structure diagram is applied for the multi-WAN device 10, and achieved by the modules of the FIG. 2 or FIG. 3. In one embodiment, the modules of FIG. 2 is used for achieving the method. Apparently the modules of FIG. 3 also can achieve the method.

In A, message 1 is the message transmitted from the second WAN interface 220 to the user 50. In one embodiment, the first network IP data payload is transmitted from the mobile IP to the user IP.

In B, message 2 is the message transmitted from the user 50 to the home agent 30. In one embodiment, the first network IP data payload is transmitted from the user IP to the mobile IP.

In C, message 3 is the message transmitted from the home agent 30 to the second access point 601, then from the second access point 601 to the second WAN interface 220. In one embodiment, the first WAN IP data payload is transmitted from the user IP to the mobile IP based on the care-of-address and mobile IP address.

In D, message 4 is the message transmitted from the second WAN interface 220 to LAN. In one embodiment, the first network IP data payload is transmitted from the user IP to the mobile IP.

Through the introduction about message transmitting, it is well known that the second network 60 can transmit and receive the message of the first network 20 to the user 50 after the first network 20 is switched to the second network 60.

The foregoing disclosure of the various embodiments has been presented, when switching the first WAN network to the second network, it can keep the continuous communication of present network, what's more, avoids network entry when the networks is switched, and achieves the seamless connection resumption between networks.

The foregoing disclosure of the various embodiments has been presented for purposes of illustration and description. It is not intended to be exhaustive or to limit the invention to the precise forms disclosed. Many variations and modifications of the embodiments described herein will be apparent to one of ordinary skill in the art in the light of the above disclosure. The scope of the invention is to be defined only by the claims appended hereto and their equivalents.

What is claimed is:

1. A multi-WAN device comprising:
a first WAN interface connected to a first network;
a second WAN interface connected to a second network, wherein the multi-WAN device communicates with a home agent by the first network or the second network;
a processor; and
a storage system, storing one or more software programs in the form of computerized codes operable to be executed by the processor, the one or more software programs comprising:
an application module, applying for a first IP address as a mobile IP address from the first network via the first WAN interface, and applying for a second IP address as a care-of-address from the second network via the second WAN interface;
a detection module, determining whether communication quality of the first network is less than a first threshold by the first WAN interface, and whether communication quality of the second network is more than a second threshold by the second WAN interface upon the condition that the communication quality of the first network is less than the first threshold;
a register module, enabling the second network upon the condition that the communication quality of the second network is more than the second threshold, and registering the care-of-address to the home agent by the second network to cause the home agent to bind the care-of-address and the mobile IP address and to transmit information of binding to the register module; and
an updating module, adding the information of binding to a routing table of the first network as a new routing rule, and receiving tunnel information relating to the second network and the home agent from the second network, and updating default routing rules about data transmitting of the first network based on the tunnel information.

2. The multi-WAN device of claim 1, wherein the first network comprises a wireless network comprising a first access point and a first DHCP server, and the application module applies for the mobile IP address from the first access point of the first network or from the first DHCP server by the first access point.

3. The multi-WAN device of claim 1, wherein the second network comprises a wireless network comprising a second access point and a second DHCP server, and the application module applies for the care-of-address from the second access point of the second network or from the second DHCP server by the second access point.

4. The multi-WAN device of claim 1, wherein the detection module detects the communication quality of the first network based on whether a CINR of the first network is less than the first threshold, uses the first network to communicate when the CINR of the first network is not less than the first threshold, and scans a CINR of the second network and keeps on using the first network to communicate when the CINR of the first network is less than the first threshold.

5. The multi-WAN device of claim 4, wherein the detection module detects the communication quality of the second network based on whether a CINR of the second network is more than the second threshold, switches from the first network to the second network when the CINR of the second network is more than the second threshold, and keeps on using the first network to communicate and continuously detects the CINR of the first network when the CINR of the second network is not more than the second threshold.

6. The multi-WAN device of claim 3, wherein process of the register module registering the care-of-address to the home agent by the second network comprises:
informing register information of the care-of-address to the second access point via the second WAN interface so that the second access point requests the home agent to register the care-of-address.

7. A routing table updating method of a multi-WAN device comprising a first WAN interface connected to a first network and a second WAN interface connected to a second network and communicating with a home agent by the first network or the second network, the method comprising:
applying for a first IP address as a mobile IP address from the first network by the first WAN interface;
detecting and determining whether communication qualities of the first network is less than a first threshold by the first WAN interface, and detecting and determining whether communication quality of the second network is more than a second threshold by the second WAN interface when the communication quality of the first network is less than the first threshold;
Enabling the second network when the communication quality of the second network is more than the second threshold, and applying for a second IP address as a care-of-address from the second network by the second WAN interface;
registering the care-of-address to the home agent by the second network so that the home agent binds the care-of-address and the mobile IP address and transmits information of binding;
adding the information of binding to a routing table of the first network as a new routing rule;
receiving tunnel information relating to the second network and the home agent from the second network, and updating default routing rules about data transmitting of the first network based on the tunnel information.

8. The routing table updating method of a multi-WAN device of claim 7, wherein the first network is a wireless network comprises a first access point and a first DHCP server, the second network is a wireless network comprises a second access point and a second DHCP server.

9. The routing table updating method of a multi-WAN device of claim 7, wherein the steps of detecting the communication quality of the first network is less than the first threshold comprising:
detecting the communication quality of the first network based on whether CINR of the first network is less than the first threshold, using the first network to communicate when the CINR of the first network is not less than the first threshold, and scanning CINR of the second network and keeping on using the first network to communicate when the CINR of the first network is less than the first threshold.

10. The routing table updating method of a multi-WAN device of claim 9, wherein the steps of detecting communication quality of the second network is more than the second threshold comprising:
detecting the communication quality of the second network based on whether CINR of the second network is more than the second threshold, switching the first network to the second network when the CINR of the second network is more than the second threshold, and keeping on using the first network to communicate and continuously detecting the CINR of the first network when the CINR of the second network is not more than the second threshold.

11. The routing table updating method of a multi-WAN device of claim 8, wherein the steps of registering the care-of-address to the home agent by the second network comprising:
the second WAN interface informs register information of the care-of-address to the second access point and the second access point requests the home agent to register the care-of-address.

12. The routing table updating method of a multi-WAN device of claim 7, wherein further comprising:
the first network communication packets are transmitted by the second network based on updated routing table of the first network.

13. The routing table updating method of a multi-WAN device of claim 7, wherein the tunnel relating to the second network and the home agent from the second network is used for transmitting the packets between the second network and the home agent.
